(19) United States
(12) Patent Application Publication
(10) Pub. No.: US 2005/0138378 A1
(43) Pub. Date: Jun. 23, 2005

(54) Method and computer system operated software application for digital signature

(76) Inventors: Makan Pourzandi, Montreal (CA); Axelle Apvrille, Biot (FR)

Correspondence Address: ALEX NICOLAESCU;Ericsson Canada Inc., Patent Department (LMC/M/P), 8400 Decarie Blvd., Town Mount Royal, QC, H4P 2N2, CA

(21) Appl. No.: 10/740,484

(22) Filed: Dec. 22, 2003

(51) Int. Cl. H04L 9/00

(52) U.S. Cl. 713/170

(57) ABSTRACT

A method and computer operated software application for digitally signing a portion of an electronic file, and for verifying such a digital signature. A portion of the file to be signed is extracted based on a computation of one or more functions, and the file portion is used for being either directly digitally signed, or for calculating a Message Digest value (MD1) and for digitally signing the MD1 value with a private key of the signer. The so-formed digital signature is appended to the file. During verification, the digital signature is removed from the file, decrypted using the signer's public key, which is known to the verifier, and the portion of the file, or respectively MD1 is obtained. The portion of the file used for the signature is again obtained and used for a similar a computation based on the one or more functions, which are also known to the verifier, for calculating a corresponding portion of the file, or another Message Digest value (MD2). MD1 and MD2 are compared, or alternatively the file portions are compared, to determine the authenticity and integrity of the file.

### BACKGROUND OF THE INVENTION

1. Field of the Invention

The present invention relates to the field of verification of the integrity and of the authenticity of an electronic file.

2. Description of the Related Art

With the increasing data traffic over electronic means, such as the Internet, the Local Area Networks (LANs) and the Wide Area Networks (WANs), methods for insuring the security of electronic documents are becoming more and more popular. Such methods are useful both for guarantying the secured transmission of electronic documents from a sender to a receiver, and for insuring the security of locally stored electronic documents.

For example, the Message Digest 5 (MD5) algorithm takes as input an electronic message or file of arbitrary length and produces an output of 128-bit “fingerprint” or “Message Digest (MD)” of the input. It is assumed that it is computationally infeasible to produce two messages having the same MD, or to produce any message having a given pre-specified target MD. The MD5 algorithm is also intended for digital signature applications, where instead of encrypting the whole file (which can be large), the MD is computed in secure manner and encrypted with a private (secret) key under a public-key cryptosystem such as the RSA.

In essence, MD5 is a reliable way to verify data integrity.

An MD can therefore be viewed as a compact digital signature for an arbitrarily long stream of data that guaranties the integrity of the original stream. An ideal MD algorithm would never generate the same signature for two different sets of input, but achieving such theoretical perfection would require a message digest as long as the input stream or file. Practical MD algorithms compromise in favour of a digital signature of modest size created with an algorithm designed to make preparation of input text with a given signature computationally infeasible. MD algorithms have much in common with techniques used in encryption, but to a different end: verification that data have not been altered since the signature was published.

The most commonly used present-day MD algorithm is the 128 bit MD5 algorithm, developed by Ron Rivest of the MIT Laboratory for Computer Science and RSA Data Security, Inc. The algorithm, with a reference implementation, was published as Internet RFC 1321 in April 1992, all of which is herein included by reference, and was placed into the public domain at that time.

Reference is now made to FIG. 1 (Prior Art) that is a high-level representation of the functioning of the MD5 algorithm. An MD function is applied on a digital file x and an MD₁ value 100 associated with the file x is calculated. Then, during a verification process, the file x′ (that may be different from file x in case, for example, a malicious attack was performed on the original file x) is obtained along with the MD value 100, action 102. In action 104, a new MD value, called MD₂ is computed using the received file x′, and in action 106 the two MD values are compared. If they match, it is concluded in action 108 that the file x and x′ are the same, i.e. the integrity check of file x is successful.

A further security mechanism used in data storage and transmission is the digital signature. A digital signature (not to be confused with a digital certificate) is an electronic signature that can be used to authenticate the identity of the sender of a message, or of a creator of a given file, or the signer of a document, and possibly to ensure that the original content of the message or document that has been sent is unchanged. Digital signatures are easily transportable, cannot be imitated by someone else, and can be automatically time-stamped.

A digital signature can be used with any kind of electronic message, whether it is encrypted or not, simply so that the receiver can be sure of the sender's identity and that the message arrived intact.

For example, in order to illustrate the concept of a digital signature, it is assumed that that sender A desires to send the draft of a contract to a lawyer B in another town, and that same sender A wants to give the lawyer B the assurance that the received document: i) was unchanged with respect to what he actually sent and ii) that the document actually originates from sender A.

For this purpose, sender A first copy-and-paste the contract document into an e-mail note. Using special software, the sender A obtains an MD of the contract document. Then he uses his private key that was previously obtained from a public-private key or from a certification authority to encrypt the MD with the private key, thus obtaining a signed file. The encrypted MD becomes the sender's digital signature of the message.

At the other end, the lawyer B receives the message.

To make sure the received file is intact and is actually from the sender A, the lawyer B makes an MD of the received message. The lawyer B then uses the public key of sender A to decrypt the received message MD. Finally, if the MD of the received message matches the decrypted MD, the received message is assumed to be both authentic (coming from sender A) and unaltered (not modified).

Reference is now made to FIG. 2, which is a high-level flowchart diagram illustrative of the functioning of a digital signature. In action 200, the MD value of file x is encrypted with a private key of the sender/originator. In action 202, the file with the signature is stored, or transmitted to a given location, and used by a given application. In action 204, an authenticity check is performed by analysing the digital signature. Action 204 may first comprise, action 206, decrypting the signature from the file using a public key of the sender/originator, and then checking the validity of the signature, action 208.

A problem was noticed in the industry regarding the additional processing burden that is put on a given computer system for performing the supplementary operations related to security. Taken individually, signing or verifying digital signatures may only take a few milliseconds on an average personal computer, which is acceptably small if it is to be done only once in a while. However, some systems require such intensive use of digital signatures that even such a limited processing overhead becomes critical.

For instance, digital signatures can be also used to protect operating systems against attacks from viruses, worms, or Trojan horses: in such cases, all trusted binary files that are stored on a given computer system and that are legitimate are digitally signed by the local user (or by a system administrator), and only allowed to be executed on the computer system if their signature can be verified. In such a manner, the authenticity of illegitimate files that are, or contain, viruses, worms and Trojan horses are always tested, and their execution can be avoided on the given computer system.

Unfortunately, with current chips, processors, and cryptographic algorithms, verifying additional signature for each an every binary file that is executed on a computer system heavily impacts the machine's processing performance. In some instances, it has been noticed that the verification of digital signatures of each and every file that is executed by a given system, may multiply the processing time by a factor of four (4), which is unacceptable in most circumstances. Other prior art methods have proposed an optimization of digital signatures for binary files, which use a cashing mechanism. This method is based on caching the signature of the binary file the first time the binary file is loaded. In subsequent accesses to the binary file, as long as there is a valid cache entry for the binary, the signature is not verified. This method needs to enforce the validity of cache entries using secure mechanisms. For example, it is possible to modify the operating system of the computer in order to invalidate a cache entry after a write access to the binary file. However, when there is a cache miss, such systems fail to provide any performance improvement.

In certain environments, the performance impact of digital signature verification is far too heavy to be widely adopted. As a consequence, in many instances system administrators are left with no other choice than to disable security mechanisms on their machines if they still want to meet the expected response time.

Accordingly, it should be readily appreciated that in order to overcome the deficiencies and shortcomings of the existing solutions, it would be advantageous to have a method and system for effectively verifying digital signatures of electronic files. The present invention provides such a method and system.

To solve the existing prior art problems related to the additional processing burden that is put on computer systems for verifying digital signatures, the present invention proposes a different method and system that provides performance in all cases and for all types of electronic files.

### SUMMARY OF THE INVENTION

In one aspect, the present invention is a method for digital signature of an electronic file, the method comprising the steps of:
a) determining a portion of the electronic file that is to used for computing a digital signature; and
b) digitally signing a block of data that consists of the determined portion and creating the digital signature of the electronic file;
wherein the portion of the electronic file that is to be used for the digital signature is computed using one or more functions that are known to a signer of the electronic file who executes the digital signature.

In another aspect, the invention is a method for digital signature verification of an electronic file, the method comprising the steps of:
a) extracting the digital signature from the electronic file;
b) determining a portion of the electronic file that was used for computing the digital signature;
c) decrypting the digital signature using a public key of the signer of the electronic file, and obtaining a block of data; and
e) comparing the portion of the electronic file that was used for computing the digital signature with the block of data for determining an authenticity and an integrity of the electronic file;
wherein the portion of the electronic file that was used for computing the digital signature is computed using one or more functions that are known to a verifier of the digital signature verification of the electronic file.

In yet another aspect, the invention is a computer-system operated software application for digitally signing an electronic file, the computer-system operated software application comprising:
a File Analyzer module determining a portion of the electronic file that is to be used for computing a digital signature; and
a Digital Signature Processing module digitally signing a block of data comprising the determined portion of the electronic file and creating a digital signature for the electronic file;
wherein the portion of the electronic file that is to be used for computing the digital signature is computed by the File Analyzer module using one or more functions that are known to a signer of the electronic file who executes the digital signature.

In yet another aspect, the invention is a computer-system operated software application for digital signature verification of an electronic file, comprising:
a File Analyzer module extracting a digital signature from the electronic file, and determining a portion of the electronic file that was used for computing the digital signature; and
a Digital Signature Processing module decrypting the digital signature using a public key of the signer of the electronic file, and obtaining a block of data that was used for computing the digital signature;
   wherein the Digital Signature Processing Module compares the portion of the electronic file that was used for computing the digital signature with the block of data for determining an authenticity and an integrity of the electronic file, wherein the portion of the electronic file that was used for computing the digital signature is computed using one or more functions that are known to a verifier of the digital signature verification of the electronic file.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level representation of the functioning of a Message Digest (MD5) algorithm;

FIG. 2 (Prior Art) is a high-level flowchart diagram illustrative of the functioning of a digital signature;

FIG. 3 is an exemplary flowchart diagram illustrative of a method according to the preferred embodiment of the invention;

FIG. 4 is another exemplary flowchart diagram illustrative of a method according to the preferred embodiment of the invention;

FIG. 5 is an exemplary schematic diagram of an electronic file used according to the preferred embodiment of the present invention;

FIG. 6 is an exemplary schematic diagram of a block of i bytes of length used according to the preferred embodiment of the present invention;

FIG. 7 is an exemplary schematic diagram of a buffer storing a suite of blocks of p bytes of length used according to the preferred embodiment of the present invention;

FIG. 8 is an exemplary high-level functional diagram of a computer-operated software diagram implementing a method described by the preferred embodiment of the invention; and

FIG. 9 is another exemplary high-level functional diagram of another computer-operated software diagram implementing a method described by the preferred embodiment of the invention.

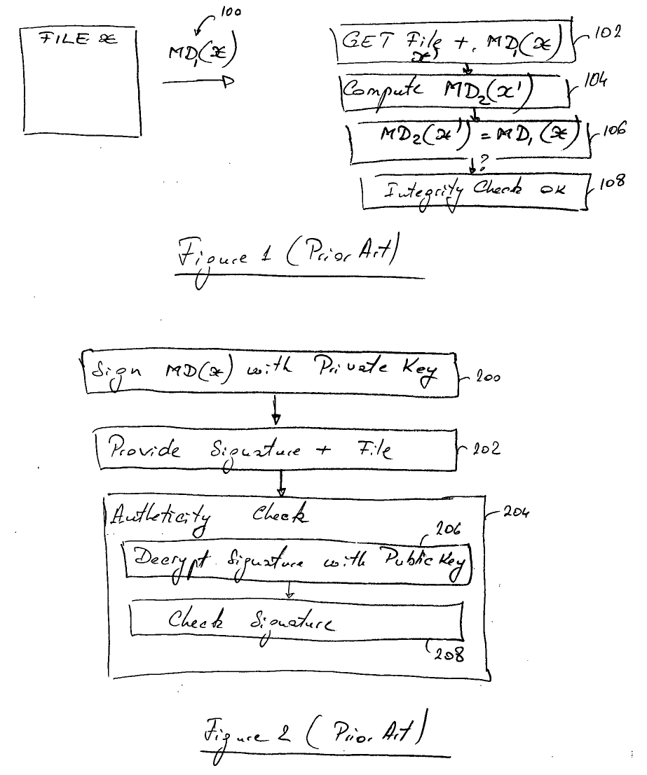

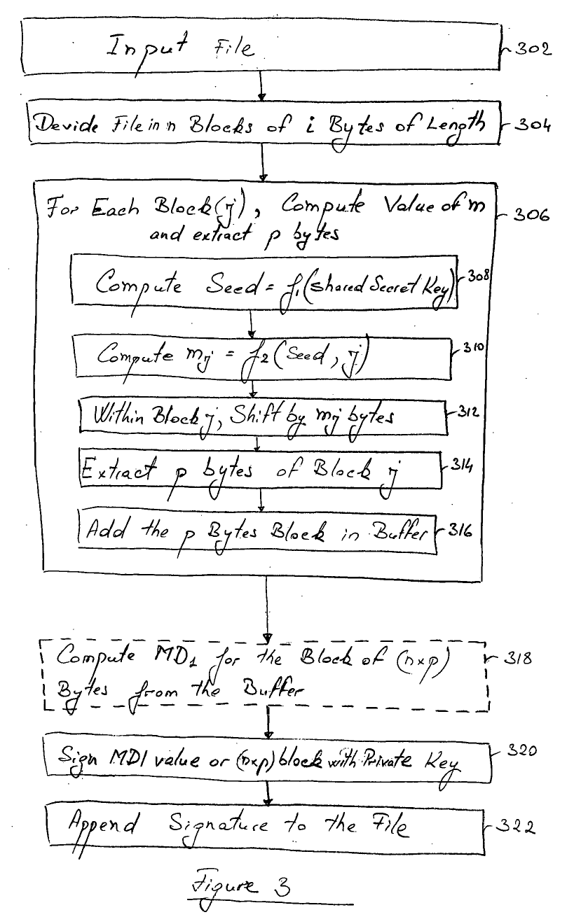

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and system that allows for the digital signing of only a portion of a given electronic file, such as a binary file, wherein the signed portion of the file is selected by using pre-specified function(s) and values that is/are only known to the legitimate creator and to the legitimate executor or reader of that file. Only signing a portion of a file reduces the processing overhead induced by the signature verification process so that signature verification becomes simpler for computer systems. Although the signed file is not 100% digitally signed, the present invention offers an optimal trade-off between security and performance for system administrators who can set up the best percentage of the file he or she desires to digitally sign. For example, instead of completely removing security mechanisms on a given computer system because of the slowdown induced on the processing by the signature verification, a system administrator may choose to sign only 20 percent of each file.

The present invention works independently of any operating system, and cryptographic algorithms, although in the preferred embodiment of the present invention digital signatures, which are based on RSA algorithms, are exemplary presented. Furthermore, according to the present invention, partial digital signature can be applied on any kind of file, including text files, audio and video streaming files, script files, executable files, and shared library files (for example Dynamic Linked Libraries (.dll) files for Microsoft Windows), although it is understood that the principal threat to a given computer system may be considered the malicious execution of unauthorized binary code, that this usually comprised in an executable file or in a shared library file.

To perform such a malicious attack, a hacker needs to copy malicious binary file on the targeted computer system, or replace existing binary code by malicious binary code in a given file. With the present invention, even by only signing a portion of a given binary file, the security related to the legitimate file is considerably augmented, since it was observed that it is difficult in practice for an attacker to modify only selected parts of an executable binary file and still maintain coherence within that file. As a matter of fact, inserting the malicious code into the binary file usually requires regenerating information sections of the binary file, such as for example the ELF (Executable and Linking Format) header to describe the position of the malicious code, and for enough contiguous memory to store the modified instructions. Therefore, even in theory it is still feasible for a hacker to modify the unsigned portions of the partially signed binary file without being detected, in practice, when such a situation occurs, the file would generally be corrupted, and therefore not executable, which would still prevent damages to the computer system.

According to the present invention, a portion of the electronic file that is to be digitally signed is first extracted from the file, using for example, one or more functions that are known to the signer of the file, and to an eventual verifier of the digital signature. The extracted portion of the file may be either immediately signed using the signer's private key, or a Message Digest value may be first computed using the extracted portion of the file, and the digital signature may be applied on the Message Digest value. For example, the file to be digitally signed may be first divided into n blocks of similar length of i bytes. Then, within each such block designated j, wherein the value of j is defined by 1<=j<=n, a block of p bytes is taken, starting at a location m bytes apart from the beginning of the block j, wherein the value of m may be computed using one or more functions f₁, f₂, etc, and the value of p is defined by 0<=p<=i. The value of m is recalculated for each block j, and the block of p bytes of each block j is copied into a buffer, thus creating a block B=(filesize/i)*p, which block is signed with a digital signature. This leads to the fact that a fraction of (p/i) of the file is digitally signed. During the verification process, the verifier has knowledge of the functions f₁, f₂ and can therefore verify the authenticity and integrity of the file by extracting the digital signature, dividing the file in similar blocks j, computing the value of m, computing a new MD value if the MD value was also used during the signature process, and compare the MD values to deduce whether or not the file is authentic and unchanged.

Reference is now made to FIG. 3, which is an exemplary flowchart diagram illustrative of a method according to the preferred embodiment of the invention. In action 302, the method starts with a selection of the given file to be digitally signed according to the present invention. Then, in action 304, the file is divided into n blocks of i bytes of length. Reference is now made jointly to FIG. 3, and to FIG. 5, which is an exemplary schematic diagram of an electronic file divided according to the preferred embodiment of the present invention. File 500 is divided into n blocks 502-508 of i bytes of length. The value of i may be chosen according to the preferences of the system administrator. With reference being further made to FIG. 3, following the division of the file into n blocks, in action 306 there is computed a value of m for each block j and p bytes are extracted from each such block, wherein 1<=j<=n, m represents the shift in the block to obtain the beginning of the zone of the block to be extracted, and p is number of bytes that are to be copied from each block j into the buffer. The value of m may be calculated using various functions. In the present exemplary scenario, the value of m is computed using two functions, f1 and f2. For example, in action 308, a Seed value is calculated as a result of function f1 applied on a shared secret key of the creator or sender of the file with digital signature. Once the value of the Seed is computed, in action 310, the value of mⱼ is computed for block j by applying the function f2 on the values of the Seed and of j. Thus, mⱼ is a function not only of the Seed value, but also of the number j that designated the current block of i bytes of length, and therefore varies from on block j to the other. In action 312, within the block j, a shift of mⱼ bytes is performed from the beginning of the block, and in action 314, the next p bytes are extracted from the block j, wherein the value of p may be defined by the system administrator. It is understood that the greater the value of p is, more of the file is to be digitally signed, and therefore more security is to be provided. In action 316, the p bytes of block j are added into a buffer.

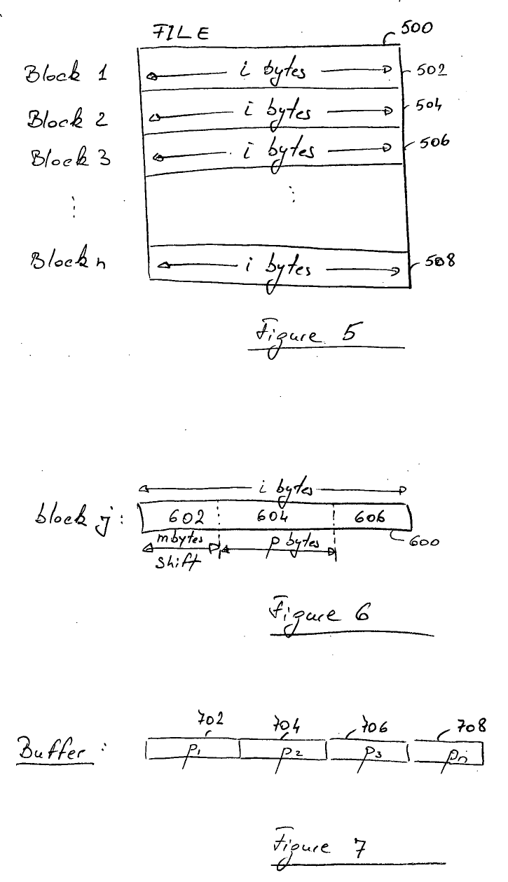

Reference is now made jointly to FIG. 3 and to FIG. 6, which is an exemplary schematic diagram of the block j 600 of i bytes used according to the preferred embodiment of the present invention. The block j 600 may comprise a first portion 602 of m bytes of length which is not considered for the digital signature, a second portion 604 of p bytes of length which is copied and considered in order to be digitally signed, and third and remaining portion 606 of i-p-m bytes of length which is again not considered for the digital signature.

As action 306 is repeated for each block j for a total of n blocks of the file under consideration, at the last occurrence of action 316, i.e. at the n^{th} occurrence, the buffer stores n×p bytes of data. Reference is now made jointly to FIG. 3 and to FIG. 7, which is an exemplary schematic diagram of a buffer 700 storing a suite of n blocks 702-708 of p bytes of length used according to the preferred embodiment of the present invention. Thus, the buffer stores (n×p) bytes of data.

Action 318 may be optional depending upon a preferred implementation of the present invention. In action 318, the method computes a Message Digest (MD) value MD1 using the n×p bytes of data of the buffer.

In action 320, if action 318 was performed, the MD1 value is encrypted, i.e. signed with the private key of the creator or sender of the file, and the so created digital signature is appended to the original file, action 322, thus creating a digitally signed file. Otherwise, if action 318 is skipped, it is the block of (n×p) bytes of data that is encrypted, i.e. signed with the private key of the creator or sender of the file, and the so created digital signature is appended to the original file, action 322, thus creating a digitally signed file.

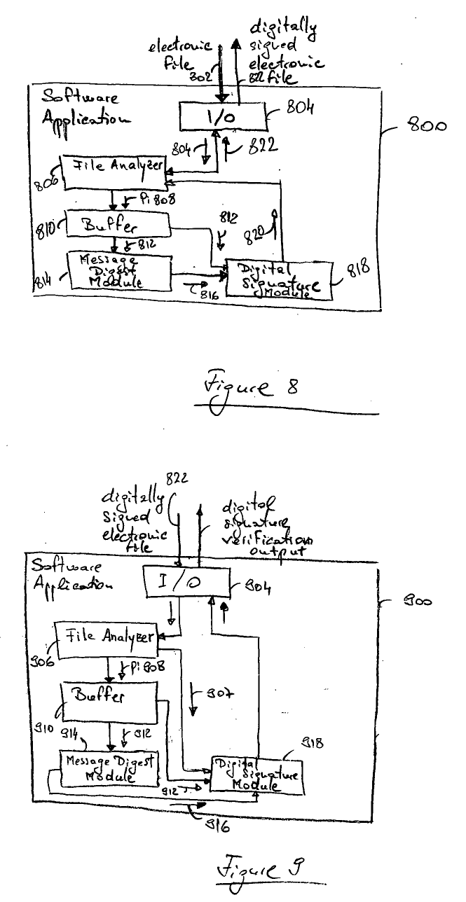

Reference is now jointly made to FIG. 3, previously described, and to FIG. 8, which is an exemplary high-level functional diagram of a computer-operated software diagram implementing a method described by the preferred embodiment of the invention. Shown in FIG. 8 is a computer-operated software application 800 that may be used for digitally signing an electronic file 802 according to the preferred embodiment of the invention. The electronic file to be digitally signed is input into an Input/Output interface 804 of the software application 800, and from there transmitted to a File Analyser module 806, which is responsible for performing actions 304 and 306 (including sub-actions 308-316), as described with reference to FIG. 3 hereinbefore. The portions of p bytes in length pᵢ 808 are copied by the File Analyzer module 806 into a Buffer 810. In case action 318, previously described is to be performed, the (n×p) bytes of data 812 of the Buffer 810 are then sent to a Message Digest module 814, which calculates the MD1 value in action 318, previously described, and the MD1 value 816 is then transmitted to a Digital Signature module 818, which is responsible for signing the MD1 value 816 with the private key of the signer, action 320. Otherwise, in case action 318, previously described, is skipped, the (n×p) bytes of data 812 of the Buffer 810 are then directly to the Digital Signature module 818, which is responsible for signing the block of (n×p) bytes of data 812 with the private key of the signer, action 320.

In both cases, the so formed digital signature 820 is sent to the File Analyzer 806 where it is appended to the electronic file in action 322. Finally, the signed electronic file 822 is output by the software application via the I/O interface 804.

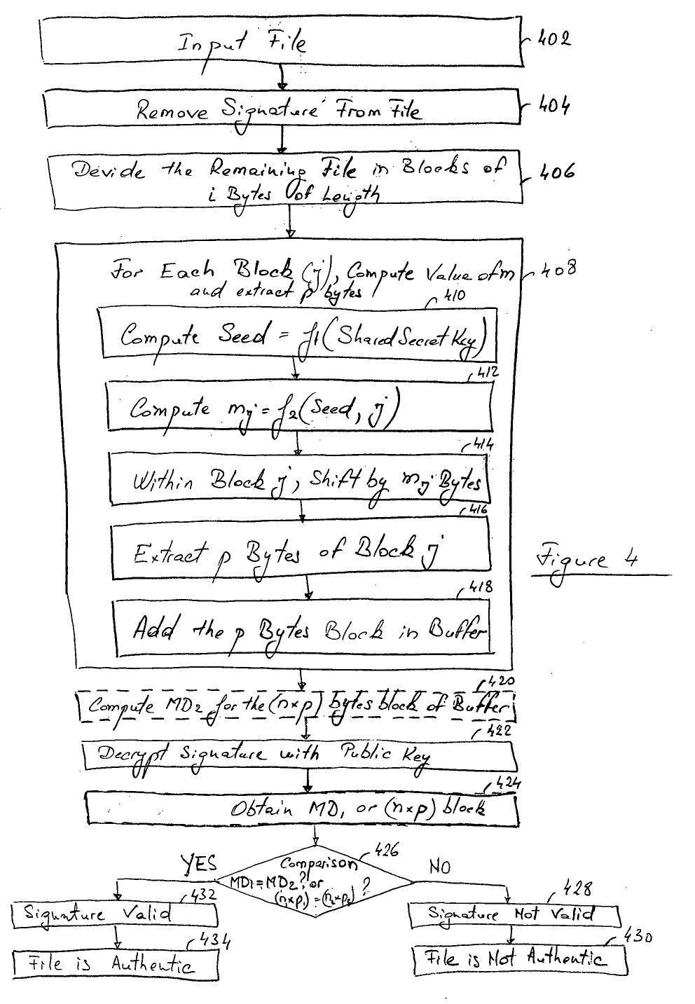

Reference is now made to FIG. 4, which is another exemplary flowchart diagram illustrative of a method for verifying a digital signature of a given file according to the preferred embodiment of the invention. In action 402, the file to be verified is taken into consideration, and in action 404 the digital signature that was added in action 322 is removed from the file. Action 406 is similar to the previously described action 304 for the division of the file into blocks, except for the fact that it is performed on the file to be evaluated, which may be different from the original file that was signed in action 320 and 322, in instances where a malicious modification has been performed on the original file. Likewise, action 408 is similar to the previously described action 306, and comprises sub-actions 410-418 which are analogous to the actions 308-316, but also performed on the file to be verified. In action 420, the method may compute a new MD value, herein called MD2 using the n×p bytes of data of the buffer, which were taken from the file to be verified. It is to be noted that action 420 is only performed if the electronic file signature was performed on the MD1 value, i.e. if the action 318 of FIG. 3 was performed. In action 422, the digital signature that was removed from the file to be verified in action 404 is decrypted using the file signer's public key, and in action 424 the MD1 value (in case action 318 of FIG. 3 was performed) or the n×p bytes of data (in case action 318 of FIG. 3 was skipped) is obtained. The verification of the authenticity and integrity of the file to be verified is performed in action 426, wherein the newly computed value of MD2 is compared to the value of MD1 (in case action 318 and 420 were performed) or the n×p bytes obtained in action 422 are compared with the n×p bytes obtained in action 424. In case they are the same, the digital signature is considered valid, action 432, and the method concludes that the file is authentic and unmodified with respect to the one that was initially signed. Otherwise, the digital signature is considered invalid, action 428, and the method concludes that the file is not authentic and/or is altered with respect to the one that was initially signed.

Reference is now jointly made to FIG. 4, previously described, and to FIG. 9, which is an exemplary high-level functional diagram of a computer-operated software diagram implementing a method described by the preferred embodiment of the invention. Shown in FIG. 8 is a computer-operated software application 900 that may be used for verifying a digital signature of an electronic file 822 according to the preferred embodiment of the invention. The digitally signed electronic file 822 which digital signature is to be verified is input into an Input/Output interface 904 of the software application 900, and from there transmitted to a File Analyser module 906, which is responsible for performing actions 404, 406, and 408 (including sub-actions 410-418), as described with reference to FIG. 4 hereinbefore. The portions of p bytes in length pᵢ 908 are copied by the File Analyzer module 906 into a Buffer 910, while the digital signature 907 extracted from the electronic file in action 404 is sent to a Digital signature module 918. According to a first variant, wherein action 318 was performed in FIG. 3, the data 912 of the Buffer 910 is then optionally sent to a Message Digest module 914, which may calculate the MD2 value in action 420, previously described, and the MD2 value 916 is then transmitted to a Digital Signature module 918 for evaluation. Meanwhile, the digital signature 907 is decrypted by the Digital Signature module 918, action 422, previously described, and the MD1 value is obtained, action 424. Finally, the MD1 value is compared with the MD2 value by the Digital Signature Module 918, and the result of the comparison is sent to the I/O interface 904.

According to a second variant, wherein action 318 was skipped in FIG. 3, the data 912 of the Buffer 910 is directly transmitted to a Digital Signature module 918 for evaluation. Meanwhile, the digital signature 907 is decrypted by the Digital Signature module 918, action 422, previously described, and the n×p bytes obtained, action 424. Finally, the n×p bytes are compared with the data 912 by the Digital Signature Module 918, and the result of the comparison is sent to the I/O interface 904.

Therefore, with the present invention it becomes possible to digitally sign only a portion of an electronic file, wherein the file's signed portion comprises of a plurality of blocks extracted from the file from locations that are only known to the legitimate signer and verification of the file.

Based upon the foregoing, it should now be apparent to those of ordinary skills in the art that the present invention provides an advantageous solution, which offers optimal conciliation between electronic file security and computer system performance. While the method and system shown and described have been characterized as being preferred, it will be readily apparent that various changes and modifications could be made therein without departing from the scope of the invention as defined by the claims set forth herein below. For example, the described exemplary method for digital signature verification refers to the calculation of the value of m using two different functions, it is understood that this value can be alternatively calculated suing any one or more functions, including a constant function, where m may be a constant. Also, although the exemplary described method and system describes signing the MD of the file instead of the entire electronic file, it is understood that the invention can also be used to sign the selected portion of the file without using previously calculating the MD value based on the selected portion. For example, with reference being made to the previously described FIGS. 3, 4, 8, and 9, according to this variant of the invention, actions 318 in FIG. 3 (respectively action 420 in FIG. 4) are skipped and the invention allows for the digital signing of the (n×p) block obtained in the action 306 (respectively action 408 in FIG. 4).

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for digital signature of an electronic file, the method comprising the steps of:
a) determining a portion of the electronic file that is to used for computing a digital signature; and
b) digitally signing a block of data that consists of the determined portion and creating the digital signature of the electronic file;
wherein the portion of the electronic file that is to be used for the digital signature is computed using one or more functions that are known to a signer of the electronic file who executes the digital signature.

2. The method claimed in claim 1, further comprising the step of:
c) prior to step b), computing a Message Digest (MD) value using the determined portion of the electronic file;
wherein the block of data that is digitally signed in step b) consists of the MD value.

3. The method claimed in claim 2, wherein step a) comprises the steps of:
a.1) dividing the electronic file into a plurality of blocks; and
a.2) from each block of the plurality of blocks, extracting a block portion and copying the block portion into a buffer;
wherein when the block portion is extracted and copied into the buffer for each block of the plurality of blocks, the buffer comprises the portion of the electronic file that is to be digitally signed.

4. The method claimed in claim 3, wherein step a.2) comprises the steps of:
a.2.1) for each block of the plurality of blocks,
computing a value m using the one or more functions; and
within a block of the plurality of blocks, at a location m bytes apart from a beginning of the block, extracting the block portion and copying the block portion into the buffer, wherein the block portion has p bytes of length.

5. The method claimed in claim 4, wherein for computing the value of m, a first function is applied on a shared secret key of the signer of the electronic file, and wherein a second function is applied on a result of the first function and on a variable j that represents the number of a current block from the plurality of blocks of the electronic file.

6. The method claimed in claim 2, further comprising the step of:
d) appending digital signature to the electronic file and creating a digitally signed electronic file.

7. The method claimed in claim 2, wherein the electronic file is a binary file.

8. The method claimed in claim 2, wherein the electronic file is an executable file.

9. The method claimed in claim 2, wherein the electronic file is a shared library file.

10. A method for digital signature verification of an electronic file, the method comprising the steps of:
a) extracting the digital signature from the electronic file;
b) determining a portion of the electronic file that was used for computing the digital signature;
c) decrypting the digital signature using a public key of the signer of the electronic file, and obtaining a block of data; and
d) comparing the portion of the electronic file that was used for computing the digital signature with the block of data for determining an authenticity and an integrity of the electronic file;
wherein the portion of the electronic file that was used for computing the digital signature is computed using one or more functions that are known to a verifier of the digital signature verification of the electronic file.

11. The method claimed in claim 10, further comprising the steps of:
e) subsequent to step b), computing a Message Digest (MD2) value using the determined portion of the electronic file;
wherein the block of data obtained in step c) comprises an MD1 value and wherein step d) comprises the step of:
d.1) comparing the MD1 value with the MD2 value.

12. The method claimed in claim 11, wherein step b) comprises the steps of:
b.1) dividing the electronic file into a plurality of blocks; and
b.2) from each block of the plurality of blocks, extracting a block portion and copying the block portion into a buffer;
wherein when the block portion is extracted and copied into the buffer for each block of the plurality of blocks, the buffer comprises the portion of the electronic file that was used for computing the digital signature.

13. The method claimed in claim 12, wherein step b.2) comprises the steps of:
b.2.1) for each block of the plurality of blocks,
computing a value m using the one or more functions; and
within a block of the plurality of blocks, at a location m bytes apart from a beginning of the block, extracting the block portion and copying the block portion into the buffer, wherein the block portion has p bytes of length.

14. The method claimed in claim 13, wherein for computing the value of m, a first function is applied on a shared secret key of the signer of the electronic file, and wherein a second function is applied on a result of the first function and on a variable j that represents the number of a current block from the plurality of blocks of the electronic file.

15. The method claimed in claim 11, wherein the electronic file is a binary file.

16. The method claimed in claim 11, wherein the electronic file is an executable file.

17. The method claimed in claim 11, wherein the electronic file is a shared library file.

18. The method claimed in claim 11, wherein if the MD1 value is equal to the MD2 value, it is concluded that the digital signature is valid and the electronic file is authentic and unmodified with respect to the electronic file that was digitally signed.

19. The method claimed in claim 11, wherein if MD1 value is not equal to MD2 value, it is concluded that the digital signature is invalid and that the electronic file is corrupted.

20. A computer-system operated software application for digitally signing an electronic file, the computer-system operated software application comprising:
a File Analyzer module determining a portion of the electronic file that is to be used for computing a digital signature; and
a Digital Signature Processing module digitally signing a block of data comprising the determined portion of the electronic file and creating a digital signature for the electronic file;
wherein the portion of the electronic file that is to be used for computing the digital signature is computed by the File Analyzer module using one or more functions that are known to a signer of the electronic file who executes the digital signature.

21. The computer-system operated software application further comprising:
a Message Digest module computing a Message Digest (MD) value using the determined portion of the electronic file, wherein the block of data that is digitally signed consists of the MD value.

22. The computer-system operated software application claimed in claim 21, further comprising:
a buffer connected to the File Analyzer;
wherein the File Analyzer acts to divide the electronic file into a plurality of blocks, and from each block of the plurality of blocks, extracts a block portion and copies the block portion into the buffer, wherein when a block portion is extracted and copied into the buffer from each block of the plurality of blocks, the buffer comprises the portion of the electronic file that is to be digitally signed.

23. The computer-system operated software application claimed in claim 22, wherein for each block of the plurality of blocks, the File Analyzer module computes a value m using the one or more functions, and within a block of the plurality of blocks, at a location m bytes apart from a beginning of the block, extracts the block portion and copies the block portion into the buffer.

24. The computer-system operated software application claimed in claim 23, wherein for computing the value of m, the File Analyzer module applies a first function on a shared secret key of the signer of the electronic file, and further applies a second function on a result of the first function and on a variable j that represents the number of a current block from the plurality of blocks of the electronic file.

25. The computer-system operated software application claimed in claim 21, wherein the File Analyzer module appends the signed MD value to the electronic file and creates a digitally signed electronic file.

26. The computer-system operated software application claimed in claim 21, wherein the electronic file is a binary file.

27. The computer-system operated software application claimed in claim 21, wherein the electronic file is an executable file.

28. The computer-system operated software application claimed in claim 21, wherein the electronic file is a shared library file.

29. A computer-system operated software application for digital signature verification of an electronic file, comprising:
a File Analyzer module extracting a digital signature from the electronic file, and determining a portion of the electronic file that was used for computing the digital signature; and
a Digital Signature Processing module decrypting the digital signature using a public key of the signer of the electronic file, and obtaining a block of data that was used for computing the digital signature;
wherein the Digital Signature Processing Module compares the portion of the electronic file that was used for computing the digital signature with the block of data for determining an authenticity and an integrity of the electronic file, wherein the portion of the electronic file that was used for computing the digital signature is computed using one or more functions that are known to a verifier of the digital signature verification of the electronic file.

30. The computer-system operated software application claimed in claim 29, further comprising:
a Message Digest module computing a Message Digest (MD2) value using the determined portion of the electronic file and sending the MD2 value to the Digital Signature Processing module;
wherein the block of data comprises an MD1 value and wherein the Digital Signature Processing module acts to compare the MD1 value with the MD2 value for determining an authenticity and an integrity of the electronic file.

31. The computer-system operated software application claimed in claim 30, wherein the File Analyzer divides the electronic file into a plurality of blocks, and from each block of the plurality of blocks, extracts a block portion and copies the block portion into a buffer, wherein when the block portion is extracted and copied into the buffer for each block of the plurality of blocks, the buffer comprises the portion of the electronic file that was used for the digital signature.

32. The computer system operated software application claimed in claim 31, wherein for each block of the plurality of blocks, the File Analyzer module computes a value m using the one or more functions, and within a block of the plurality of blocks, at a location m bytes apart from a beginning of the block, extracts the block portion and copies the block portion into the buffer.

33. The computer system operated software application claimed in claim 32, wherein for computing the value of m, the File Analyzer applies a first function on a shared secret key of the signer of the electronic file, and further applies a second function on a result of the first function and on a variable j that represents the number of a current block from the plurality of blocks of the electronic file.

34. The computer-system operated software application claimed in claim 30, wherein the electronic file is a binary file.

35. The computer-system operated software application claimed in claim 30, wherein the electronic file is an executable file.

36. The computer-system operated software application claimed in claim 30, wherein the electronic file is a shared library file.

37. The computer-system operated software application claimed in claim 30, wherein the Digital Signature Processing module concludes that the digital signature is valid and the electronic file is authentic and unmodified with respect to the electronic file that was digitally signed if the MD1 value is equal to the MD2 value.

38. The computer-system operated software application claimed in claim 30, wherein the Digital Signature Processing module concludes that the digital signature is invalid and that the electronic file is corrupted if the MD1 value is not equal to the MD2 value.
